(19) United States
(12) Patent Application Publication
(10) Pub. No.: US 2004/0117277 A1
(43) Pub. Date: Jun. 17, 2004

(54) Distributing accounts in a workflow system

(76) Inventors: Joseph Tagupa, Berkeley, CA (US); Paul Lauffenburger, Grants Pass, OR (US); Umadevi Vootukuri, Fremont, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/321,894

(22) Filed: Dec. 16, 2002

(51) Int. Cl. G06F 17/60

(52) U.S. Cl. 705/30

(57) ABSTRACT

A system and method of distributing accounts in a workflow system based in part on whether or not an individual resolved the account. The system and method include resolution based account distribution and non-resolution based account distribution. Also included are one or more data storage areas for storing new accounts, resolved accounts and/or unresolved accounts. In one embodiment, accounts may be distributed according to many factors, for example, individual resolution points, account distribution type, resolution type and priority, some or all of which may be updated on a periodic basis.

### BACKGROUND OF THE INVENTION

1. Field of the Invention

This invention generally relates to the field of account distribution in a workflow management system. More particularly, this invention relates to account distribution systems and methods for assigning collection accounts to individual collectors in a substantially automated manner and allowing the selection of certain criteria to manage the account distribution process.

2. Description of the Related Technology

Businesses and individuals use conventional workflow management systems for various purposes, including for managing workgroups. For example, organizations may use workflow management systems to manage and distribute the work performed by each individual in the organization.

In workflow management contexts, it is challenging for an organization to manage the assignment and flow of work between many different individuals. Moreover, the status of each project, product design and actual product manufacturing is often difficult to assess at a glance. Rather complex data compilation or report generation is typically required before such status is clear. This is especially true for the collections business, where groups of collectors are assigned the task of collecting debts from a relatively large number of debtors.

Thus, a need exists for a more flexible and powerful workflow management system that allows an organization to assign, move and schedule accounts between various individuals assigned to work on the account. In addition, the system should allow monitoring of the status of the accounts and redistribution of accounts that have an unresolved status to other individuals for resolution of the accounts. Collectors' performance in resolving accounts previously worked on would preferably be taken into account when assigning newly received accounts for collection.

### SUMMARY OF CERTAIN INVENTIVE ASPECTS

In satisfaction of the above-mentioned need, embodiments of the present invention provide a workflow management system that, for example, efficiently assigns work to a collector, monitors the status of the collector's work on particular projects, and allows for the transfer of work from one collector to another. The system is configured not only to transfer work throughout collectors in an organization, but also to display status information derived from a data storage area, and manipulate or update the data storage area as work is performed.

Also described is a system and method of controlling the distribution of accounts to collectors based on the resolution or non-resolution of the account. The system described herein overcomes the limitations described above by, for example, allowing a debt collector to “work” the particular debtor accounts and record the progress and resolution status of each account. In debt collection systems that utilize aspects of the invention, new accounts that are received might not be assigned directly to the collector, but are instead assigned into a new account data area. The new accounts are then assigned from the new account data area to a particular collector, who works to resolve the account.

One aspect of the invention includes a system for distributing accounts in a workflow management system, the system comprising at least one data storage area for storing account data, wherein the account data comprises one or more from the group comprising: new account data, resolved account data, and unresolved account data, an account assignment module in data communication with the at least one data storage area and configured to assign an account to an individual based at least in part on a previous account resolution status and a resolution history of a plurality of individuals, and at least one computing device in data communication with the account assignment module and configured to allow the individual to receive account assignment information and the account data.

This additionally comprises the system wherein the account assignment module comprises a general inventory distribution module. This additionally comprises the system wherein the account assignment module further comprises a resolution based account distribution module. Still further is the system wherein the account assignment module further comprises a non-resolution based account distribution module. This further comprises the system wherein the account assignment module is further configured to assign accounts based in part on one or more from the group comprising: account resolution points for the plurality of individuals, distribution type for the accounts, resolution type for the accounts, and resolution priority for the accounts.

This additionally comprises the system wherein the account assignment module is further configured to assign accounts on a periodic basis, and wherein one or more from the following group is updated on a periodic basis: the account data, the account resolution status, the resolution track record of the plurality of individuals, the account resolution points for the individuals, the distribution type for the accounts, the resolution type for the accounts, and the resolution priority for the accounts. This additionally comprises the system wherein the periodic basis is selected from the group comprising: an hourly basis, a weekly basis, a bi-weekly basis, a monthly basis, or a bimonthly basis. This further comprises the system wherein the workflow management system is used for the collection of debts.

An additional aspect of the invention includes a method of distributing accounts in a workflow management system, the method comprising storing account data on at least one data storage area, wherein the account data comprises one or more from the group comprising: new account data, resolved account data, and unresolved account data, communicating with the at least one data storage area to receive the account data, assigning at least one account to an individual based at least in part on a previous account resolution status and a resolution history of a plurality of individuals, and communicating with at least one computing device that is configured to allow at least one of the plurality of individuals to receive account assignment information and the account data.

An additional aspect of the invention includes a system for distributing accounts in a workflow management system, the system comprising means for storing account data on at least one data storage area, wherein the account data comprises one or more from the group comprising: new account data, resolved account data, and unresolved account data, means for communicating with the at least one data storage area to receive the account data, means for assigning at least one account to an individual based at least in part on a previous account resolution status and a resolution history of a plurality of individuals, and means for communicating with at least one computing device configured to allow at least one of the plurality of individuals to receive account assignment information and the account data.

A further aspect of the invention includes a method of resolution based account distribution in a workflow management system, the method comprising updating resolution points for a plurality of individuals, determining if a new account data storage area has at least one new account, moving the at least one new account to an assigned account data storage area, and reducing a resolution count of the at least one new account, wherein the resolution points and resolution count are used in a subsequent account distribution.

An additional aspect of the invention includes a method of non-resolution based account distribution in a workflow management system, the method comprising entering an event by a first individual that is assigned to at least one account, wherein the event indicates a non-resolution status for the at least one account, copying the at least one account having the non-resolution status to a temporary data storage area, removing the account from an inventory of the first individual by moving the at least one account from the temporary data storage area to an unresolved data storage area, assigning the at least one account stored in the unresolved data storage area to a second individual, and monitoring a resolution status of the second individual.

### BRIEF DESCRIPTION OF THE DRAWINGS

FIG. 1 is an account data flow diagram in accordance with one embodiment of the present invention.

FIG. 2 is a block diagram of an account distribution system in accordance with one embodiment of the present invention.

FIG. 3 is a top-level flow diagram of one embodiment of a Resolution Based Account Distribution (RBAD) process as may be implemented by the RBAD module shown in FIG. 2.

FIG. 4 is a detailed flow diagram of one embodiment of a RBAD process as may be implemented by the RBAD module shown in FIG. 2.

FIG. 5 is a flow diagram of one embodiment of a Non-Resolution Based Account Distribution (Non-RBAD) process as may be implemented by the Non-RBAD module shown in FIG. 2.

### DETAILED DESCRIPTION OF CERTAIN EMBODIMENTS

The following detailed description of certain embodiments presents various descriptions of specific embodiments of the present invention. However, embodiments of the present invention can be embodied in a multitude of different ways as defined and covered by the claims. In this description, reference is made to the drawings wherein like parts are designated with like numerals throughout.

Definitions

The following provides a number of useful possible explanations and clarifications of terms used in describing certain embodiments of the disclosed invention. In general, a broad explanation of a term is desired when alternative meanings exist.

Input Devices: Input devices are capable of transmitting information from a user to a computer, for example, a keyboard, rollerball, mouse, voice recognition system or other device. The input device may also be a touch screen associated with the display, in which case the user responds to prompts on the display by touching the screen. The user may enter textual information through the input device such as the keyboard or the touch-screen.

Instructions: Instructions refer to computer-implemented steps for processing information in the system. Instructions can be implemented in software, firmware or hardware and can include any type of programmed step undertaken by components of the system.

Local Area Network (LAN): One example of the Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

Microprocessor: The microprocessor may be any conventional general purpose single- or multi-chip microprocessor, such as one or more of the Pentium® line of processors, a 8051 processor, a MIPS® processor, a Power PC® processor, an ALPHA® processor, or other general purpose microprocessor, including others yet to be developed. In addition, the microprocessor may be any conventional special purpose microprocessor, such as a digital signal processor or a graphics processor. The microprocessor typically has conventional address lines, conventional data lines, and one or more conventional control lines.

Modules: A system may be comprised of various modules as discussed in detail below. As can be appreciated by one of ordinary skill in the technology, each of the modules may comprise various sub-routines, procedures, definitional statements and macros. Each of the modules are typically separately compiled and linked into a single executable program. Therefore, a description of each of the modules is used for convenience to describe the functionality of certain embodiments of the system. Thus, the processes that are undergone by each of the modules may be arbitrarily redistributed to one of the other modules, combined together in a single module, or made available in, for example, a shareable dynamic link library.

Networks: The system may include any type of electronically connected group of computing systems, including, for example, one or more of the networks from the following non-exhaustive list: Internet, Intranet, Local Area Networks (LAN) or Wide Area Networks (WAN). In addition, the connectivity to the network may be, for example, by way of remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, wireless, set-top, or any other desired type of configuration. As used herein, an Internet includes network variations such as public Internet, a private Internet, a secure Internet, a private network, a public network, a value-added network, an Intranet, and the like. In other words, as used herein, the term network refers to any type of connectivity between computing devices for the transfer of data.

Operating Systems: The system may be used in connection with various operating systems, such as those from the following non-exhaustive list: UNIX, Disk Operating System (DOS), OS/2, Windows 3.X, Windows 95, Windows 98, Windows NT, including other operating systems not listed or yet to be developed. New operating systems and revisions of existing operating systems are continually being developed, and these are also within the scope of the present invention.

Programming Languages: The system may be written in one or more of many programming language such as C, C++, Ada, BASIC, Pascal, Java, and FORTRAN, and executed under one or more of the many well-known operating systems. C, C++, Ada, BASIC, Pascal, Java, and FORTRAN are industry standard programming languages for which many commercial compilers can be used to create executable code.

Transmission Control Protocol (TCP): TCP is a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses Internet Protocol (IP) as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions and multiplexing multiple connections through a single network connection. Finally, TCP is responsible for encapsulating information into a datagram structure.

Overview

While various embodiments of the invention are described in the context of a debt collection system, one skilled in the technology will appreciate that the systems and methods described herein could similarly be utilized to implement many other types of applications in addition to the debt collection system. As the debt collection system is presented merely as an illustrative embodiment, the scope of the invention is not limited to this embodiment, but rather includes these additional implementations as well.

In the context of the debt collection system embodiment, accounts are typically received for collection from outside customers or clients. These accounts, rather than being directly assigned to a collector, are stored in a data storage area for new accounts. Accounts that have been received for collection are sometimes referred to as account inventory, or just inventory. Accounts in the inventory are assigned to collectors based on the various collectors' past performance in resolving previous accounts. This is referred to herein as Resolution Based Account Distribution (RBAD). Collectors are awarded resolution points for resolving accounts based on the type of resolution that was achieved. For example, accounts can be resolved favorably by receiving payment in full for the outstanding balance, agreeing to a compromise or settlement (e.g., payment of less than the full balance in return for settling the account), agreeing to billing terms (e.g., down payment plus specified monthly payments), filing suit, or initiating administrative wage garnishment. Accounts can also be resolved unfavorably, also referred to as non-resolved, for example, by an inability to locate the debtor or an inability to collect from the debtor. Accounts for which a non-resolution event has been recorded are stored in a data storage area for non-resolved accounts and subsequently reassigned to a new collector based on similar account assignment criteria as described above. This is referred to herein as Non-Resolution Based Account Distribution (Non-RBAD). Accounts may also be recalled or returned to the customer at the customer's request. In this case, the account is removed from the inventory by the account distribution system.

A debt collector who has been assigned to “work” the particular debtor accounts is also responsible for reporting the progress and resolution status of each account. In this way, past account resolution status may be monitored and recorded for use in subsequent account assignment and distribution decisions. Resolution performance history for a collector is recorded by the award of resolution points based on the type of resolution event reported. Accounts may be distributed to collectors according to many factors, for example, collector resolution points, account distribution type, resolution type and priority, some or all of which may be updated on a periodic basis. Such a debt collection system is capable of rewarding the collectors with the more desirable accounts when they are successful in resolving the existing accounts. In this way, collectors are encouraged and motivated to resolve both the easier and harder accounts in their inventory quickly and with favorable results. The overall effect is that a greater number of accounts are moved through the system more efficiently than would otherwise be possible, accounts are resolved more quickly and more favorably, and the customer is satisfied and likely to be a long-term customer.

As used herein, the term “account” in the debt collection embodiment refers to all of the related information on a particular debt collection matter. For example, the information in an account can include the debtor's name, address, telephone number, debt information, similar information about co-debtors, leads and references, and much more additional information that is useful to a collector. The account is normally stored in a data storage area, for example, in a relational database system. The account may include data that spans several tables in the relational database system.

Description of the Figures

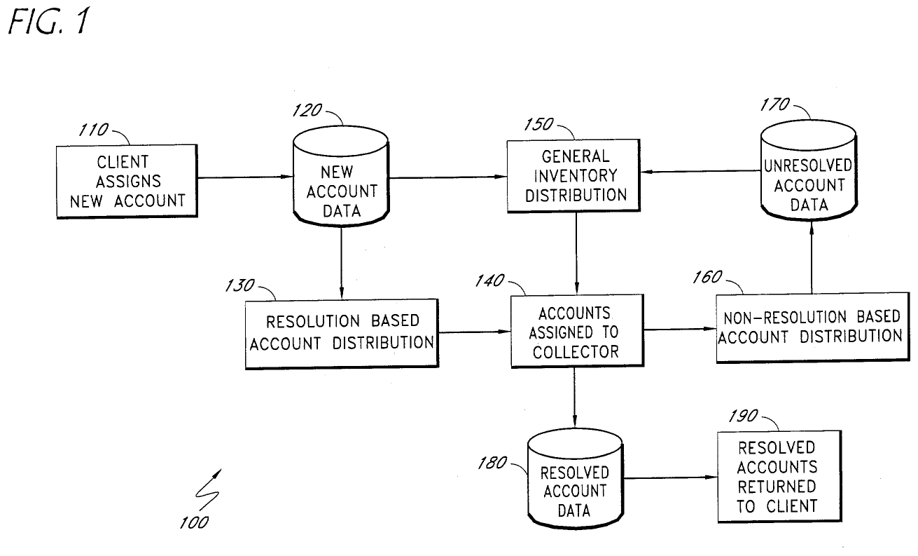

FIG. 1 is an account data flow diagram 100 in accordance with one embodiment of the present invention. In this embodiment, at a block 110 new account data is assigned for processing, for example, as would be the case when a customer or client assigns a new account to be resolved. The new accounts are placed on a new account data area 120 for storage until assigned. In one embodiment, the new account data area 120 is a database storage system capable of storing and retrieving information, such as those commercially available from, for example, the Oracle Corporation or IBM. However, other embodiments in which data is stored in other ways or on other types of data storage devices are also within the scope of the present invention. In other embodiments, the new account data storage area 120 may be split among a plurality of physical data storage devices. The data in the new account data area 120 may be accessed by one or both of a resolution based account distribution (RBAD) processing module 130 or a general inventory distribution processing module 150. The RBAD module 130 or general inventory distribution module 150 are configured to retrieve the new accounts from the new account data area 120 and assign them to an employee or other individual at a processing module 140, for example, a collector in a debt collection system embodiment, to be worked on or resolved.

In the case where the collector assigned to the account fails to resolve the account satisfactorily, a non-resolution based account distribution (Non-RBAD) processing module 160 is configured to remove the account from that collector's work list and place the account in an unresolved account data storage area 170. The unresolved account data storage area 170 may be a database storage system or other data storage device similar to that described above for the new account data storage area 120. The unresolved account data storage area 170 may be a separate device from the new account data storage area 120, or alternatively both data storage areas 120, 170 may reside on the same physical data storage device. In addition, the unresolved account data storage area 170 may be split among a plurality of physical data storage devices. The general inventory distribution module 150 retrieves accounts that may have been stored on the unresolved account data storage area 170 and assigns the unresolved accounts to another collector for resolution, for example, by placing the unresolved accounts on a data storage area for accounts assigned to a collector 140.

In the case where the collector assigned to the account succeeds in resolving the account satisfactorily, the now-resolved account is placed in a resolved account data storage area 180. The resolved account data storage area 180 may be a database storage system or other data storage device similar to that described above for the new account data storage area 120 and the unresolved account data storage area 170. The resolved account data storage area 180 device may be separate from either or both of the new account data storage area 120 device and the unresolved account data storage area 170 device. Alternatively, more than one of the data storage areas 120, 170, 180 may reside on the same physical data storage device, or still further, all three data storage areas 120, 170, 180 may reside on the same physical data storage device. In addition, the resolved account data storage area 180 may be split among a plurality of physical data storage devices. A resolved account may be returned to the client at a block 190, which may close out the account and inform the client the manner in which the account has been resolved.

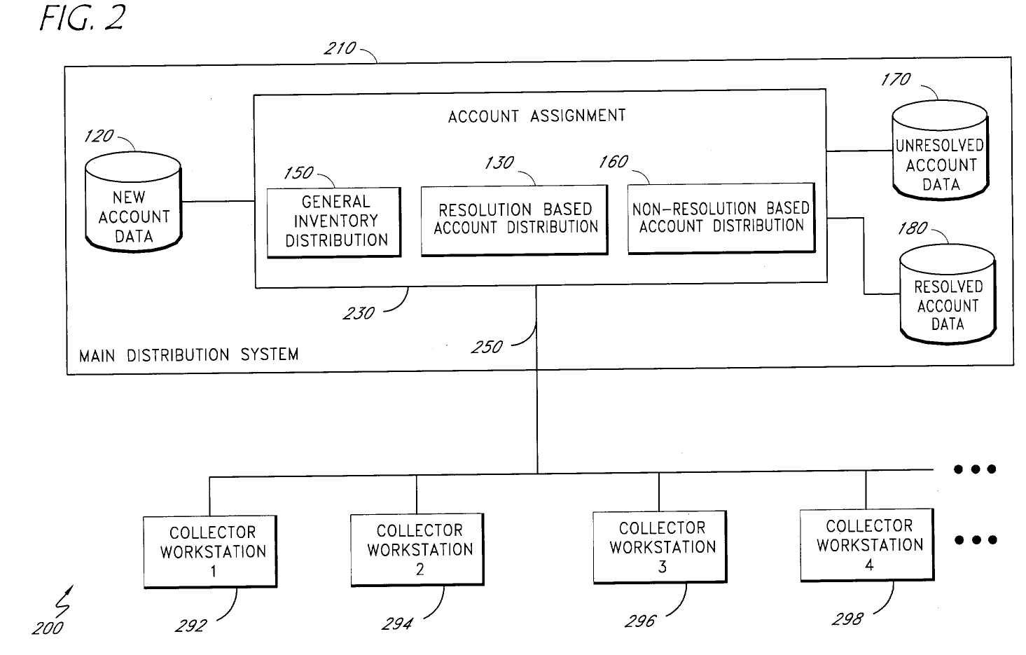

FIG. 2 is a block diagram of an account distribution system 200 in accordance with one embodiment of the present invention. This embodiment includes a main distribution system 210, which comprises the new account data storage area 120, the unresolved account data storage area 170, the resolved account data storage area 180, and an account assignment module 230. The account assignment module 230 is comprised of one or more additional modules or submodules, for example, the general inventory distribution module 150, the RBAD module 130, and the Non-RBAD module 160. As one of skill in the technology would appreciate, also within the scope of the present invention are other embodiments of the main distribution system 210 and the account assignment module 230 that are comprised of additional or fewer modules, or that may perform the processing of these modules in other modules than those shown in the embodiment in FIG. 2. One of skill in the technology would also appreciate that the modules may include computer instructions written in one or more of the various programming languages for execution on a microprocessor or other computing device on which one or more of the various operating systems may be executing.

The account assignment module 230 shown in FIG. 2 is in data communication with one or more collector workstations 292, 294, 296, 298, via a data communication path 250. The data communication path 250 may be a network as shown in FIG. 2, for example, a LAN or WAN utilizing the TCP/IP communication protocol. However, many other ways of data communication may be utilized as well, for example, a modem connection or a wireless link. Although for purposes of simplicity of illustration the collector workstations 292, 294, 296, 298 are shown in FIG. 2 as being located near one another and near the main distribution system 210, one or more of the collector workstations 292, 294, 296, 298 may alternatively be separated by very long distances from the other collector workstations or from the main distribution system 210. Many forms of modem data communication paths allow very large separation distances between the various communicating devices.

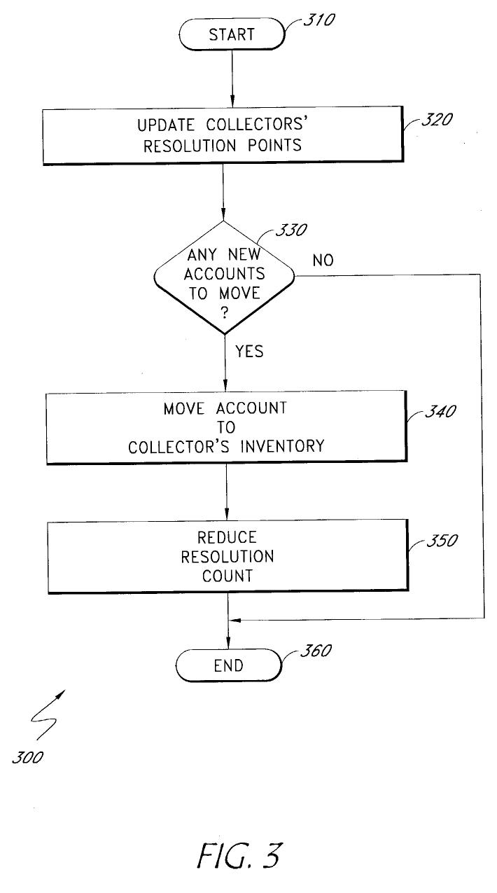

FIG. 3 is a top-level flow diagram of one embodiment of a RBAD process 300 as may be implemented by the RBAD module 130 shown in FIG. 2. In one embodiment, the RBAD process 300 executes on a daily basis for those account resolution types for which the distribution period is daily. In other embodiments, other distribution periods may include either periodic or aperiodic intervals, for example, hourly, bi-hourly, twice daily, three times daily, or any of a multitude of various distribution periods. In one embodiment, the RBAD process 300 begins at a start state 310. The RBAD process 300 then moves to an update collectors' resolution points state 320. For example, in one embodiment this state 320 may include taking a count of account resolutions earned by a collector and multiplying by an account resolution ratio, and optionally rounding the product of this multiplication down to the nearest whole number. Many other ways of computing and updating collectors' resolution points are also possible and are within the scope of the present invention. Following the state 320, the RBAD process 300 moves to a decision state 330, where it is determined if there are any new accounts to move. The decision state 330 determines if there is at least one account to move to a collector provided that the maximum number of accounts to move in a period, for example, a week, has not been reached.

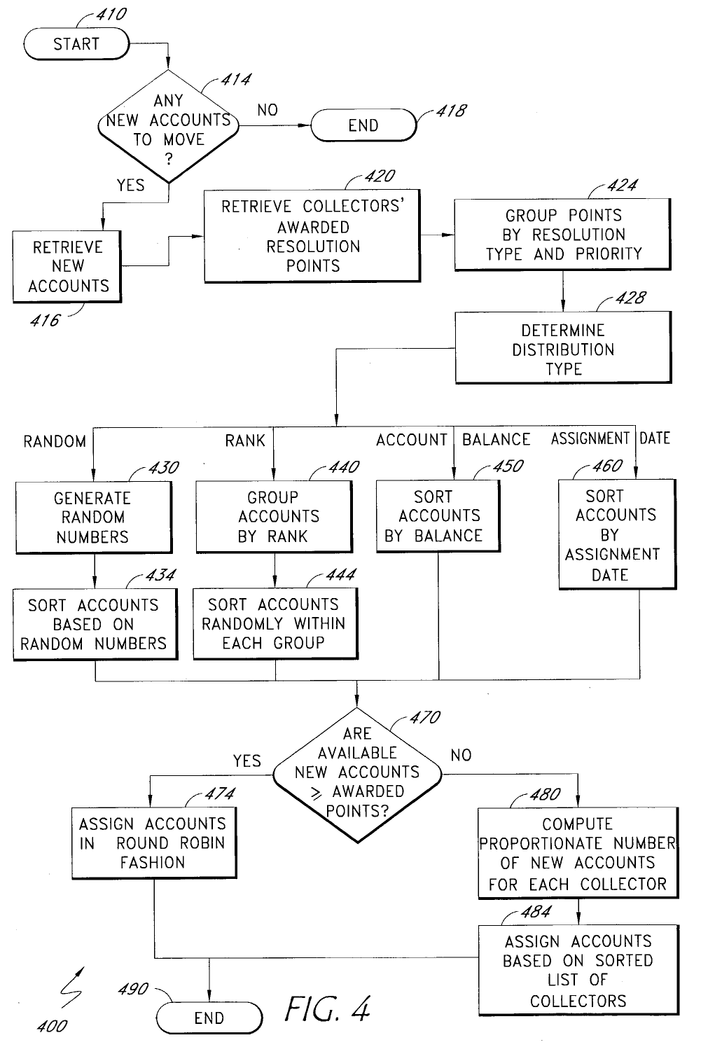

If it is determined at the decision state 330 that there are not any new accounts to move, the RBAD process 300 then moves to an end state 360, at which point the RBAD process terminates. If, however, it is determined at the decision state 330 that there are new accounts to move, the RBAD process 300 then moves to a state 340 for moving one or more accounts to a collector's inventory. The state 340 assigns accounts that are in the new account data area 120 to collectors based on certain criteria, which are described in greater detail below in relation to FIG. 4. Having moved the account to a collector's inventory in the state 340, the RBAD process 300 then moves to a state 350 for reducing the resolution count. In the state 350, the count of the account resolution is reduced by an appropriate amount. In one embodiment, the appropriate amount is calculated by subtracting the reciprocal of the account resolution ratio for each account that is moved. Many other ways of calculating the appropriate amount by which to reduce the count of the account resolution are also possible and are within the scope of the present invention. The RBAD process 300 proceeds from the state 350 to the end state 360, at which point the RBAD process terminates.

FIG. 4 is a detailed flow diagram of one embodiment of a RBAD process 400 as may be implemented by the RBAD module 130 shown in FIG. 2. In this embodiment, the RBAD process 400 begins at a start state 410. Following the start state 410, the process 400 moves to a decision state 414, where it is determined if there are any new accounts to move. If it is determined at the decision state 414 that there are not any new accounts to move, the RBAD process 400 proceeds to an end state 418, at which point the RBAD process 400 terminates. If, however, it is determined at the decision state 414 that there are new accounts to move, the RBAD process 400 proceeds to a state 416 for retrieving new accounts. The state 416 retrieves the available new business accounts from the new account data area 120, for example, for a certain client group, to be assigned to collectors as described in greater detail below in relation to the additional states of the RBAD process 400 shown in FIG. 4.

After the process 400 has retrieved the available new business accounts, the RBAD process 400 moves to a state 420 and retrieves any collectors' awarded resolution points. Collectors are awarded resolution points for resolving accounts based on the type of resolution that was achieved. For example, accounts can be resolved favorably by receiving payment in full for the outstanding balance, agreeing to a compromise or settlement (e.g., payment of less than the full balance in return for settling the account), agreeing to billing terms (e.g., down payment plus specified monthly payments), filing suit, or initiating administrative wage garnishment. The resolution performance history for each collector is recorded by the award of resolution points based on the type of resolution event reported.

In the state 420, the awarded resolution points of the collectors, for example, in each particular client group, may be retrieved. The process 400 then moves to a state 424, where the resolution points are grouped by resolution type and priority. In one embodiment, the resolution points may be grouped by a priority of highest to lowest, although many other ways of grouping resolution points may be performed as well. After the process 400 has grouped the resolution points, the RBAD process moves to a state 428 and determines the type of distribution to be performed. In one embodiment, the distribution types may include, for example, random sorting, sorting by rank, sorting by balance, and sorting by assignment date.

The random sorting distribution type includes the random shuffling of the new accounts in the new account data area 120 before being distributed to the collectors. The random sorting can be thought of as analogous to the random shuffling of a deck of playing cards. The sorting by rank distribution type includes the sorting of the new accounts in the new account data area 120 according to, for example, the risk or collectability rank of the accounts. For example, the sorting by rank can be from the best account (e.g., most collectable) to the worst account (e.g., least collectable). The sorting by balance distribution type includes sorting the new accounts by account balance, for example, from highest balance to lowest balance. The sorting by assignment date distribution type includes sorting the new accounts according to the dates the accounts were assigned by the client. For example, the new accounts may be assigned by sorting from the oldest account to the most recent account, where the oldest account refers to the account that was assigned the longest time ago.

If it is determined at the state 428 that the distribution type is random, the RBAD process 400 proceeds to a state 430 and generates random numbers. In one embodiment, at the state 430 at least one distinct random number is generated for each new account and the random number is assigned to the account. After the random numbers have been generated at the state 430, the process 400 moves to a state 434 and sorts the accounts in the new account list based on the random number that was generated and assigned to the account at the state 430. In this way, accounts are capable of being shuffled in an unpredictable, random fashion before being assigned to collectors. The RBAD process 400 then proceeds to a decision state 470 as discussed in greater detail below.

If, however, the process 400 determines at the state 428 that the distribution type is by rank, the RBAD process 400 proceeds to a state 440 and groups the accounts by rank. In one embodiment, the state 440 groups the accounts according to a ranking of the risk or collectability assessment of the accounts. The process 400 then moves to a state 444 and shuffles the accounts within each ranked group in a random manner similar to that described above in relation to states 430 and 434 for the random distribution type. The RBAD process 400 then proceeds to the decision state 470 as discussed below.

If, however, the process 400 determines at the state 428 that the distribution type is by account balance, the RBAD process 400 proceeds to a state 450 and sorts the accounts by account balance. In one embodiment, the state 450 sorts the accounts from a highest to a lowest account balance. However, other embodiments may be implemented that include, for example, sorting accounts from the lowest to the highest account balance. The RBAD process 400 then proceeds to the decision state 470 as discussed below.

If, alternatively, the process 400 determines at the state 428 that the distribution type is by assignment date, the RBAD process 400 proceeds to a state 460 and sorts the accounts by the date the client assigned the account. In one embodiment, the state 460 sorts the accounts from an oldest assigned account to a most recent. However, other embodiments may be implemented that include, for example, sorting accounts from the most recent to the oldest account assignment dates. The RBAD process 400 then proceeds to the decision state 470 as discussed below.

In one embodiment, for the cases of the random sorting, sorting by balance, and sorting by assignment date distribution types, a single group of sorted accounts is generated as described above. In the case of the sorting by rank distribution type, a plurality of groups may be generated, for example, one group of sorted accounts may be generated for each rank number. For each of the sorted accounts, the process 400 moves to the decision state 470 and determines whether an available new account is equal to or more than the awarded new account points in the account list. If the process 400 determines at the decision state 470 that the new account is equal to or more than the awarded new account points in the account list, the process 400 then moves to a state 474 and assigns the account to a collector. In one embodiment, the account assignment at the state 474 is performed in a round robin manner until the awarded points are resolved, which can be thought of as analogous to the distribution of a deck of playing cards to participating players. The RBAD process 400 then proceeds to an end state 490, at which point the RBAD process 400 terminates. The end state 490 performs the same processing as the end state 418 described above, but is drawn as a separate state in FIG. 4 only for purposes of simplicity and clarity of the drawing.

If, however, the process 400 determines at the decision state 470 that the new account is not equal to or more than the awarded new account points in the account list, the process 400 moves to a state 480 and computes the proportionate number of new accounts for each collector. In one embodiment, the computation performed at the state 480 includes dividing the awarded points of the collector by the total awarded points of all the collectors in the list. In this embodiment, the quotient of this division is multiplied by the total number of available new accounts, which results in the computation of the proportionate number of accounts. These proportionate numbers may have an integer part and a decimal (fractional) part. For the integer part of the proportionate number, the state 480 assigns accounts in the round robin manner described above. For the fractional part of the proportionate number, the state 480 sorts the collectors in the list by numerical order of the fractional part, for example, highest to lowest, and corresponding account resolution date, for example, oldest to most recent.

After the process 400 has computed the proportionate number of new accounts for each collector, the RBAD process 400 moves to a state 484 and assigns the remaining accounts based on the sorted list of collectors as described above in relation to the state 480. Some collectors who have lower fractional parts as computed in the state 480 may be left out without being assigned as many, or even any, new accounts. In this case, the left out points are accumulated and used in the computation the next time the account distribution is determined. After the process 400 has assigned the remaining accounts based on the sorted list of collectors, the RBAD process 400 moves to the end state 490. In addition to the embodiment of the states 480 and 484 that is described herein, other embodiments may be implemented that perform the computations of the states 480 and 484 in other ways, which are also within the scope of the present invention. Still further, those skilled in the technology will appreciate that other embodiments of the detailed flow of the RBAD process 400 may be implemented, and that these alternative embodiments are also within the scope of the present invention.

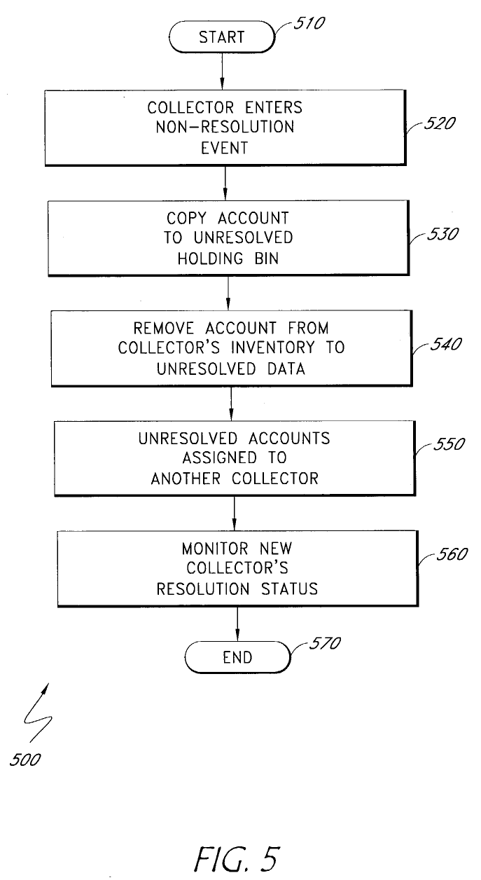

FIG. 5 is a flow diagram of one embodiment of a Non-RBAD process 500 as may be implemented by the Non-RBAD module 160 shown in FIG. 2. In this embodiment, the Non-RBAD process 500 begins at a start state 510. The Non-RBAD process 500 then moves to a state 520 and allows the collector to enter a non-resolution event for an account, for example, an unable to locate event and an unable to collect event. In one embodiment, the collector is able to enter a non-resolution event via the collector workstation 292, 294, 296, 298 using an input device, for example, a keyboard, rollerball, mouse, voice recognition system or other input device. An account for which the collector enters a non-resolution event is considered as a non-resolved account. After the process 500 has allowed the collector to enter the non-resolution event for an account, the Non-RBAD process 500 then proceeds to a state 530 and copies non-resolved accounts to a non-resolved account holding bin, which may be thought of as a temporary storage area for the non-resolved accounts taken from the collectors but not yet reassigned to new collectors. In this way, the collector from whom the account has been taken away may still remove the account from the holding bin any time before it is assigned to a new collector by resolving the account or by manually removing it.

After the process 500 has copied non-resolved accounts to the non-resolved account holding bin, the Non-RBAD process 500 moves to a state 540 and removes accounts from the collectors' account inventory to the unresolved account data area 170. In one embodiment, the processing at the state 540 may recur on a periodic basis, for example, on a weekly basis, and may be performed automatically at a predetermined time of day, or may be performed manually at the initiation of an operator or other employee. The process 500 then moves to a state 550 and assigns the non-resolved accounts in the unresolved account data area 170 to another collector for resolution. In one embodiment, the general inventory distribution module 150 as shown in FIGS. 1 and 2 may perform the processing of the state 550. The new collector to whom the previously unresolved account has been assigned at the state 550 typically tries to resolve the account. If the new collector is successful in resolving the account, they may receive special recognition or a special award as an incentive for being successful where a previous collector was unsuccessful.

After the process 500 has assigned the non-resolved accounts to another collector, the Non-RBAD process 500 then moves to a state 560 and monitors and tracks the new collector's resolution status of the previously unresolved account that was assigned to the new collector at the state 550. To assist the monitoring of the effective use of the non-resolution events and the new collector's status of the account, a periodic report may be generated. After the process 500 has monitored the new collector's resolution status, the Non-RBAD process 500 then proceeds to an end state 570, at which point the Non-RBAD process 500 terminates. In addition to the embodiment of the Non-RBAD process 500 shown in FIG. 5 and described herein, those skilled in the technology will appreciate that other embodiments of the Non-RBAD process 500 may be implemented, and that these alternative embodiments are also within the scope of the present invention.

As discussed above, embodiments of the present invention may utilize one or more modules to assign or distribute accounts. In one embodiment, one such module is referred to as the general inventory distribution module 150, which allows the collections management system to balance and adjust the inventory of collection accounts. Other modules that may be utilized to assign and distribute the accounts include the resolution based account distribution (RBAD) module 130 and the non-resolution based account distribution (Non-RBAD) module 160. These modules are configured to manage the stream of accounts. The RBAD module 130 may additionally be configured to assign to the collector a certain number of new accounts based on the collector's resolution of a certain number of previous accounts. In this way, the collector may be rewarded with preferred accounts from the new account data area 120 for the resolution of previous accounts. Thus, collectors may be provided with motivation to resolve their account inventory quickly (e.g., removing previous accounts by resolving them and receiving new accounts to resolve). In one embodiment, the Non-RBAD module 160 is capable of taking one or more accounts away from the collectors if they fail to resolve them (e.g., taking non-resolved accounts away from the collector and giving them to other collectors to resolve).

As an illustrative example, one can view collections as analogous to a manufacturing process. Bad debts, in the form of new accounts, come in the back door and resolved accounts flow out the front door. This is shown in FIG. 1, where the new accounts come in at the left side (see reference number 110 in FIG. 1), and resolved accounts flow out at the right side (see reference number 190 in FIG. 1). The most favorable resolution is to contact the debtor and work out payment in full, but there are also other possible resolutions. Accounts between the “back door” and the “front door” can be referred to as the inventory in the manufacturing analogy. The client generally desires the accounts be resolved as quickly as possible, but also do not desire the collectors to cut corners so that the most favorable resolution can be attained. Taking the analogy one step further, each collector can be thought of as a machine (or step) in the manufacturing process. Some “machines” are faster and more proficient than others are. Also, some debts may require more work to resolve than others, while conversely some may be easier to resolve than others.

Some collectors may tend to resolve the easiest accounts first, and if allowed to determine their own work patterns would “cream” the inventory, in other words resolving only the easier accounts and not bringing the more difficult accounts to resolution. Included in the numerous advantages of the account distribution system 200 as described herein, including the RBAD module 130 and Non-RBAD module 160, is that collectors are motivated to resolve both the easier and more difficult accounts.

There are a number of possible outcomes of a collector working an account. These may include, but are not limited to, the following:

Payment in full;

Compromise or settlement (e.g., accepting less the full balance as payment in full);

Placing the account in billing (e.g., receiving a good faith down payment and agreeing to receive monthly payments);

Filing of a suit or administrative wage garnishment (AWG) (e.g., the debtor is uncooperative, but balance owed and debtor's income is sufficient for legal action);

Skip trace complete (e.g., audited and approved);

Unable to locate the debtor;

Unable to collect; and

Account recalled by the client (e.g., in some cases an account may be recalled prior to resolution).

Certain of the possible outcomes include the debtor sending payment, e.g., as in the first three outcomes listed above. An additional outcome also includes the customer accepting the compromise or settlement terms. A still further outcome may include reviewing and approving the proposed action. In the case of legal actions, the legal or AWG department may review and approve the legal action. This outcome may additionally include verifying that the collectors put forth a sufficient effort to negotiate favorable terms. Another outcome in the above list may be completed when the collector codes an account as the skip trace being complete. This outcome may additionally include a quality control collector reviewing the account and approving it as closed. Still additional outcomes in the list may be referred to as non-resolutions, in which case the account may be redistributed or reassigned to another collector for resolution. In one embodiment, the long-term status of the account may be tracked. If the collector to whom an account has been reassigned can resolve the account, they may be rewarded in one or more of various ways.

In one embodiment, the RBAD module 130 includes an event-based model for account processing. During the processing of an account, activity performed on the account may be recorded as a diary of events, the events being coded to describe the event. The following non-exhaustive list of events may be captured by the RBAD module 130 and used in the account resolution:

New money payment in full;

Added into billing;

Added into billing—no credit to collector;

AWG approved;

Suit approved;

Unable to collect;

Unable to locate;

Skip trace complete—audit approved;

Account recalled by customer; and

Account returned—low balance.

In one embodiment, each of the events is captured and counted on a periodic basis, for example, on a daily basis, and the counts of events are used as inputs to the RBAD module 130 for the account distribution determination. For the sake of example, following is one out of many possible tables that may be generated and maintained to facilitate the distribution of accounts:

| Resolution | Distribution | Distribution | Distribution | Distribution |
|---|---|---|---|---|
| Priority | Frequency | Ratio | Type | Limit |
| 1 through 8 | Daily or | Account per | Random, | Maximum Per |
| | Weekly | Resolution | Rank, | Distribution |
| | | | Balance, | |
| | | | Assignment | |
| | | | Date | |

Such a table including rows and columns may be maintained for each collector or team of collectors. The term “team of collectors” may refer to a group of one or more collectors working the same type of accounts. For example, there may be 92 collectors working a Department of Education account. These collectors would, in this example, be considered a team of collectors. This may also be referred to as the collector's focus. Also set for the team may be an overall maximum number of accounts assigned in a week per collector and a separate new business account data area. The new account data area 120 refers to the collection of accounts received from the client but not yet distributed to the collector to start working the account. In other words, this refers to the inventory of unworked accounts.

In one embodiment, on a periodic basis, for example, on a nightly basis, after some or all of the collectors have left work, the events (e.g., as listed above) are counted and a number of resolution points are awarded to each collector. Once awarded, the collector does not lose the resolution points. In addition, the account distribution may be performed. For the sake of illustration, in one embodiment, the daily distribution is performed each day Monday through Friday. The resolution points for the given ratio are converted into accounts and a certain number of accounts are pulled from the new account data area 120 and distributed to the collector. On another periodic basis, for example, on a weekly basis, distribution points may be converted into accounts and awarded to the collector. In one embodiment, for each team of collectors there may be a maximum number of accounts that can be awarded during a certain period. In this way, once the maximum number of accounts awarded is reached for the period, no more accounts may be awarded for the duration of that period. In a further embodiment, distributions awarded one period can be used in future periods if the maximum is hit.

While various aspects of the present invention have been described herein primarily in the context of the debt collection system embodiment, this is for illustrative purposes and by no means limits the scope of the present invention to this particular embodiment. One skilled in the technology will appreciate that many other embodiments of the present invention exist that are likewise within the scope of the present invention. In other words, the present invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A system for distributing accounts in a workflow management system, the system comprising:
at least one data storage area for storing account data, wherein the account data comprises one or more from the group comprising: new account data, resolved account data, and unresolved account data;
an account assignment module in data communication with the at least one data storage area and configured to assign an account to an individual based at least in part on a previous account resolution status and a resolution history of a plurality of individuals; and
at least one computing device in data communication with the account assignment module and configured to allow the individual to receive account assignment information and the account data.

2. The system of claim 1, wherein the account assignment module comprises a general inventory distribution module.

3. The system of claim 2, wherein the account assignment module further comprises a resolution based account distribution module.

4. The system of claim 3, wherein the account assignment module further comprises a non-resolution based account distribution module.

5. The system of claim 1, wherein the account assignment module is further configured to assign accounts based in part on one or more from the group comprising: account resolution points for the plurality of individuals, distribution type for the accounts, resolution type for the accounts, and resolution priority for the accounts.

6. The system of claim 5, wherein the account assignment module is further configured to assign accounts on a periodic basis, and wherein one or more from the following group is updated on a periodic basis: the account data, the account resolution status, the resolution track record of the plurality of individuals, the account resolution points for the individuals, the distribution type for the accounts, the resolution type for the accounts, and the resolution priority for the accounts.

7. The system of claim 6, wherein the periodic basis is selected from the group comprising: an hourly basis, a weekly basis, a bi-weekly basis, a monthly basis, or a bi-monthly basis.

8. The system of claim 1, wherein the workflow management system is a debt collection system.

9. A method of distributing accounts in a workflow management system, the method comprising:
storing account data on at least one data storage area, wherein the account data comprises one or more from the group comprising: new account data, resolved account data, and unresolved account data;
communicating with the at least one data storage area to receive the account data;
assigning at least one account to an individual based at least in part on a previous account resolution status and a resolution history of a plurality of individuals; and
communicating with at least one computing device that is configured to allow at least one of the plurality of individuals to receive account assignment information and the account data.

10. The method of claim 9, wherein the workflow management system is a debt collection system.

11. A system for distributing accounts in a workflow management system, the system comprising:
means for storing account data on at least one data storage area, wherein the account data comprises one or more from the group comprising: new account data, resolved account data, and unresolved account data;
means for communicating with the at least one data storage area to receive the account data;
means for assigning at least one account to an individual based at least in part on a previous account resolution status and a resolution history of a plurality of individuals; and
means for communicating with at least one computing device configured to allow at least one of the plurality of individuals to receive account assignment information and the account data.

12. The system of claim 11, wherein the workflow management system is a debt collection system.

13. A method of resolution based account distribution in a workflow management system, the method comprising:
updating awarded resolution points for a plurality of individuals;
determining if a new account data storage area has at least one new account;
moving the at least one new account to an assigned account data storage area; and
reducing a resolution count of the at least one new account, wherein the awarded resolution points and resolution count are used in a subsequent account distribution.

14. The method of claim 13, further comprising:
retrieving the awarded resolution points for each of the individuals;
grouping the awarded resolution points by a resolution type and a priority;
determining an account distribution type; and
sorting the at least one new account according to the account distribution type.

15. The method of claim 14, wherein the account distribution type is selected from the group consisting of: a random distribution, an account rank distribution, an account balance distribution, and an account assignment date distribution.

16. The method of claim 14, further comprising determining whether the at least one new account meets or exceeds the awarded resolution points.

17. The method of claim 16, wherein the moving the at least one new account is performed in a round robin fashion if the at least one new account meets or exceeds the awarded resolution points.

18. The method of claim 16, wherein the moving the at least one new account is performed by computing a proportionate number of new accounts for each of the individuals and assigning the at least one new account based on a list of the individuals sorted according to the proportionate number of new accounts if the at least one new account does not meet or exceed the awarded resolution points.

19. A method of non-resolution based account distribution in a workflow management system, the method comprising:
entering an event by a first individual that is assigned to at least one account, wherein the event indicates a non-resolution status for the at least one account;
copying the at least one account having the non-resolution status to a temporary data storage area;
removing the account from an inventory of the first individual by moving the at least one account from the temporary data storage area to an unresolved data storage area;
assigning the at least one account stored in the unresolved data storage area to a second individual; and
monitoring a resolution status of the second individual.

20. The method of claim 19, wherein the workflow management system is a debt collection system, and wherein the first individual is a first debt collector and the second individual is a second debt collector.
